(19) United States
(12) Patent Application Publication
(10) Pub. No.: US 2008/0188977 A1
(43) Pub. Date: Aug. 7, 2008

(54) Processing, Storage And Distribution System For Perishable Food Products

(75) Inventor: Roger Keith Palmer, Auckland (NZ)

Correspondence Address: BIRCH STEWART KOLASCH & BIRCH, PO BOX 747, FALLS CHURCH, VA, 22040-0747, US

(73) Assignee: FOODCAP INTERNATIONAL LMITED, Auckland (NZ)

(21) Appl. No.: 11/665,721

(22) PCT Filed: Oct. 17, 2005
(86) PCT No.: PCT/NZ2005/000274

§ 371 Date: Dec. 21, 2007

(30) Foreign Application Priority Data
Oct. 18, 2004 (NZ) 536035

(51) Int. Cl. B65G 1/137; G06F 19/00; B65G 1/10; A22C 18/00; B65G 13/00

(52) U.S. Cl. 700/215; 700/216; 700/218

(57) ABSTRACT

A distribution system for perishable or contaminable food products includes automated storage apparatus for storing articles in a temperature controlled environment. The apparatus includes a number of product carrying shelves arranged on a carousel. The shelves are moveable by rotation of the carousel to facilitate placement or removal of articles on or from the shelves. Each shelf consists of a number of laterally spaced elongate projecting members.

### FIELD

This invention relates to a centralised distribution system for perishable or contaminable food products. The invention has particular application to meat products.

Throughout this specification it is to be understood that references to “meat” include all forms of meat of all descriptions generally considered to be edible, for example including without limitation fish, beef, pork, lamb, poultry and offal.

### BACKGROUND

Perishable food products present some fundamental distribution problems. There is a strong consumer preference for freshness, and there are strict time constraints in which the perishable products (particularly food products such as meat, for example) must be sold, marked down or thrown out.

Therefore, in the case of the centralised production and distribution of food perishables (such as meat, produce, delicatessen and bakery products) orders cannot usually be placed earlier than a day before delivery. The problem is compounded by retailers preferring to have as much flexibility as practicable regarding the number of stock items that they order. Processed food perishables which are ready for retail cabinet display, particularly processed meat products, are commonly referred to in the field as “cabinet ready”.

In the case of processed foods, the less time that elapses between production and delivery to a retail outlet, the better. In the case of whole foods, the less time that elapses between harvest and delivery to the retail outlet, the better. These time constraints mean that there is typically not enough time to process, package and deliver an order when distance to the store is taken into account.

### OBJECT

It is an object of the invention to provide a centralised distribution system or cabinet ready system for perishable or contaminable food products which will ameliorate one or more disadvantages of existing systems.

Alternatively or additionally, it is an object of the invention to provide a centralised distribution system or cabinet ready system for perishable or contaminable food products which will at least provide the public with a useful alternative.

Further objects of the invention will become apparent from the following description.

### SUMMARY OF THE INVENTION

Accordingly in a first aspect the invention consists in a meat distribution method comprising the steps of

providing a plurality of packaged retail meat products,
introducing the plurality of packaged retail meat products into a central storage facility having a plurality of product carrying structures in a temperature controlled environment and having a transfer means to transfer the packaged products to or from the product carrying structures,
identifying the location of the packaged products within the storage facility,
removing selected products in response to receipt of an order for the selected products by moving one or more of the product carrying structures or by moving the transfer means, and
distributing the products to fulfill the order.

Preferably the method includes the step of storing the packaged products in the central storage facility for a predetermined period of time.

Preferably the method includes the step of identifying the packaged products other than by using a label, receiving the order, and labelling the retrieved products according to the order.

Preferably the method includes storing individual cabinet ready packaged meat products in the central storage facility.

In a second aspect the invention consists in a method of centralised distribution of meat, the method including the steps of

storing packaged retail meat products in a central storage facility,
monitoring the time at which each product was introduced into the facility,
receiving an order for products stored in the facility, and
selecting products from the facility that have been stored therein for a predetermined period of time to satisfy the order.

Preferably the predetermined time period is determined dependent on the product type or the product processing history.

In a third aspect the invention consists in a method of centralised distribution of meat, the method including the steps of

storing packaged retail meat products in a central storage facility,
monitoring demand for the meat products,
introducing further packaged retail meat products into the central storage facility dependent on the demand such that the retail meat products are stored in the central storage facility for a predetermined period of time calculated to enhance the retail shelf life of the meat.

Preferably the predetermined time is calculated dependent on one or more factors including: the type of meat; the type of meat cut; the slaughter process used; the cooling profile of the meat prior to introduction into the storage facility; the demand for the product; the type of processing that the product has undergone; the type or location of a retail outlet to which the product is to be dispatched.

In a fourth aspect the invention consists in a method of centralised processing and distribution of meat, the method including the steps, of

placing post slaughter meat in a reusable container and storing the meat within the container,
removing the meat from the container and processing the meat into retail meat products, packaging the retail meat products,
storing the packaged products in a central storage facility for a predetermined period of time,
receiving a retail order,
selecting packaged products in the central storage facility dependent on the retail order, placing the selected products in a reusable container, and
transporting the selected products in the container to a retail facility.

Preferably the method includes the step of storing the products in the central storage facility without being labeled.

Preferably the method includes the step of labeling the products prior to the step of placing the selected products in a reusable container for transport to the retail facility.

Preferably the predetermined period of time is calculated to enhance the shelf life of the retail meat product.

In a fifth aspect the invention consists in a method of centralised distribution of meat, the method including the steps of

providing a plurality of packaged retail meat products,
introducing the packaged products to a central storage facility having a plurality of movable product carrying structures,
identifying the packaged retail meat products by means other than a product label, removing selected products from the storage facility in response to receipt of an order for the selected products,
distributing the products to fulfill the order.

Preferably the method includes the step of storing the products in the central storage facility without being labeled.

Preferably the method includes the step of labeling the products during or after removal of the products from the storage facility.

Preferably the meat products are stored in the central storage facility for a predetermined period of time calculated to enhance the shelf life of the retail meat product.

In a sixth aspect the invention consists in a method of centralised distribution of meat, the method including the steps of

providing a plurality of packaged retail meat products,
introducing the packaged products to a central storage facility having a plurality of movable product carrying structures,
identifying the packaged retail meat products by recording or identifying the location of the relevant product,
removing selected products from the storage facility in response to receipt of an order for the selected products,
labeling the products, and
distributing the labeled products to fulfill the order.

In a seventh aspect the invention consists in automated storage apparatus for storing articles in a temperature controlled environment, the apparatus comprising a plurality of product carrying shelves arranged on a carousel, the shelves being moveable by rotation of the carousel to facilitate placement or removal of articles on or from the shelves, and each shelf comprising a plurality of laterally spaced elongate projecting support members.

Preferably the lateral spacing between adjacent support members is selected dependent on the size of the articles to be stored.

Preferably the apparatus includes a control system to track the articles stored therein independent of any label that may be carried by an article.

Preferably the control system tracks articles based on location within the apparatus.

In an eighth aspect the invention consists in automated storage apparatus for storing articles in a temperature controlled environment, the apparatus comprising

a plurality of product carrying shelves arranged on a carousel, the shelves being moveable to facilitate placement or removal of articles on or from the shelves, each shelf comprising a plurality of laterally spaced elongate projecting support members,
a conveyor to transport articles to or from the apparatus, the conveyor including a plurality of spaced rollers, and
a transfer means for transferring articles between the conveyor and a shelf, the transfer means comprising a plurality of fingers adapted to interdigitate with the rollers to lower or lift articles to or from the conveyor and adapted to interdigitate with the elongate projecting members of a shelf to lower or lift articles to or from the shelf.

Preferably the transfer means is adapted to lift one or more articles from one of the conveyor or the shelf, and move in a direction parallel to the projecting members, the fingers and the rollers to lower the one or more articles onto the other of the conveyor or shelf.

In a ninth aspect the invention consists in a centralised distribution process for a perishable food product, including

providing a reusable container,
placing the product in the container and sealing the container
transporting the container to a central storage facility
removing the product from the container and wrapping the product storing the wrapped product,
receiving a retail order for the product
retrieving the product from the storage facility
transporting the product to a retail outlet.

In a tenth aspect the invention consists in a centralised distribution process for a perishable product, including

transporting the product to a central storage facility,
wrapping the product in a retail package,
storing the wrapped product
receiving a retail order for the product from a retailer,
retrieving the product from storage,
labelling the product dependent on the retailers requirements
transporting the labelled product to the retailer

Preferably the step of labelling the product includes affixing a price to the product, the price being dependent on the retailer's pricing structure.

In an eleventh aspect the invention consists in a containerised distribution process for a perishable food product, including

providing a first reusable container,
placing the product in the container and sealing the container
transporting the container to a central storage facility
removing the product from the container and wrapping the product
storing the wrapped product,
receiving a retail order for the product
retrieving the product from the storage facility
placing the retrieved product in a second reusable container
sealing the container
transporting the container to a retail outlet.

Preferably the method includes the step of sterilising the first container for re-use as a first reusable container or for use as a second reusable container.

Preferably the first reusable container and the second reusable container are of the same form.

In a twelfth aspect the invention consists in meat product distribution apparatus including a storage facility having a plurality of product carrying structures in a temperature controlled environment,

a conveyor means to introduce or remove packaged retail meat products to or form the storage facility,
transfer means to transfer the packaged products to or from the conveyor means and the product carrying structures,
identification means to identify the location of the packaged products within the storage facility,
control means to receive an order for selected products and cause the transfer means to remove the selected products from the product carrying structures, and use the conveyor means to convey the selected products from the storage facility so that the products may be distributed to a remote location to fulfill the order.

The invention also consists in any new feature or combination of features disclosed herein.

### DRAWING DESCRIPTION

At least one preferred embodiment of the invention will be described with reference to the accompanying drawing Figures in which:

FIG. 1 is a schematic diagram of part of a meat processing facility,

FIG. 2 is a diagrammatic plan view of a processing cell and a storage system for processed products,

FIG. 3 is a diagrammatic side elevation of the storage system shown in FIG. 2,

FIG. 4 is a diagrammatic front elevation of the storage system shown in FIGS. 2 and 3,

FIG. 5 is a diagrammatic plan view of part of a product transfer apparatus for transfer of products to the storage system shown in FIGS. 2 to 4, with a packaged product shown on a delivery conveyor,

FIG. 6 is a diagrammatic end elevation of the apparatus of FIG. 5 in a first position,

FIG. 7 is a diagrammatic end elevation of the apparatus of FIG. 5 in a second position in which the product has been lifted clear of a delivery conveyor,

FIG. 8 is a diagrammatic end elevation of the apparatus of FIG. 5 in a third position in which the product is provided above a product carrying structure of the storage system, and

FIG. 9 is a diagrammatic end elevation of the apparatus of FIG. 5 in a fourth position in which the product has been delivered to the product carrying structure of the storage system.

### DESCRIPTION OF PREFERRED EMBODIMENTS

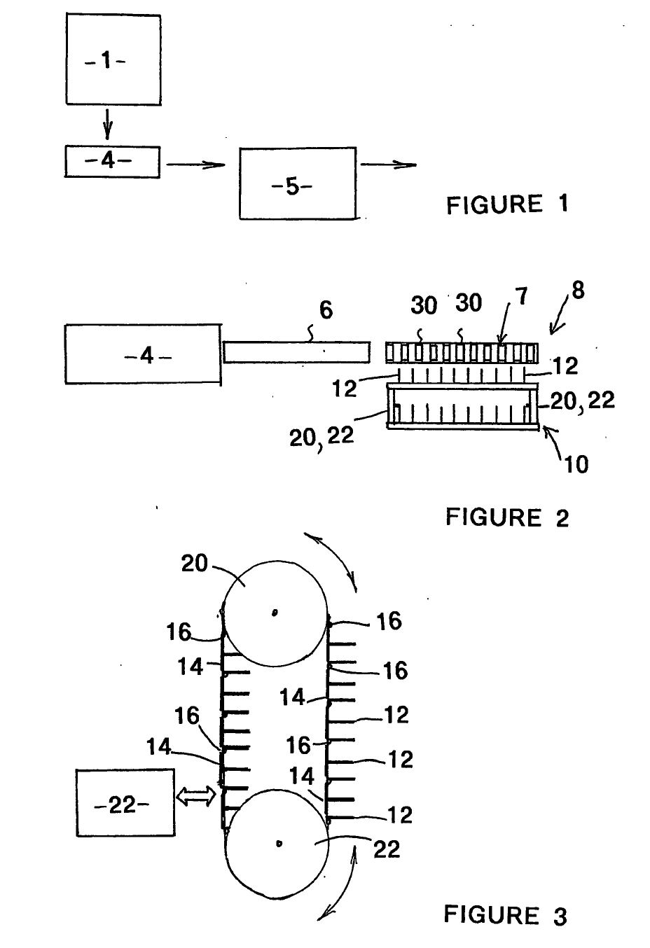

Referring to FIG. 1, a schematic outline diagram of a meat processing and distribution process is shown. Although the process will be described with reference to processing and distribution of meat products, it will be seen by those skilled in the art that the invention may be applicable to distribution and/or processing of a variety of other perishable food products including without limitation agricultural or horticultural produce (both edible or inedible), natural and semi-processed food products and organic products generally. The process also has general application to products in which a controlled atmosphere is desirable or necessary for ensuring product quality or longevity.

In FIG. 1, an inventory 1 preferably having a controlled temperature environment to retard or minmise bacterial growth, is provided in which the perishable ingredients, such as meat primals are stored and cooled if necessary. The ingredients are placed in rigid reusable containers which are transported to the inventory 1 where they are stored. The filled containers are preferably introduced, put away and retrieved to and from the inventory 1 by automated means such as a conveyor and/or crane system. The inventory 1 has one or more container carrying or support structures, each having a plurality of racks or shelves on which containers are placed. These are preferably arranged in rows leaving aisles in between the rows of shelves in which an automated transport device, such as a crane. The structures are also preferably constructed or arranged to provide spaces between containers to allow air circulation between containers. In a preferred embodiment the transport apparatus is automated, using a control system whereby the crane is moved to a predetermined location along an aisle, and then moves loading forks, or similar loading apparatus, to a required rack or shelf to remove or deliver a container to the required rack or shelf location.

The containers contain ingredients for meat processing. As mentioned above, these ingredients will primarily be meat primals. However, certain containers will contain other ingredients that may be used in a meat processing operation, for example breadcrumbs, batter, curing ingredients, marinades, sausage ingredients and casings, seasoning, by-products such as purge and trim and semi-finished goods.

The container in which the ingredients are placed may be the same as or similar to that described in our granted U.S. Pat. Nos. 5,670,195 and 6,194,012, the contents of which are incorporated herein by reference in their entirety. The container is sealed following introduction of the meat or other ingredient and preferably has a unique identifier associated with it. In the preferred embodiment the identifier is provided by applying an RFID (Radio Frequency Identification) tag to the container. However other methods may be used, for example applying a bar code or a label.

The container includes a base, one or more side walls, and a lid. The container has standardized external dimensions which provide a means for handling so as to allow automated handling of the container. Thus an external rib provides a collar which may be used by lifting and transport apparatus, such as the crane referred to above, to engage with the collar and handle the container. Since the external dimensions of the container are standardized, the handling apparatus may handle all the containers in the inventory. The containers wall(s) may also include a taper to allow one container to be stacked within another. The taper may also facilitate automated handling.

A valve is provided in the lid of each container. Once sealed, the atmosphere within each container may be modified or pressurized, for example by using the valve to evacuate the air within the container surrounding the ingredients and replace it with a desired gas (such as carbon dioxide in the preferred embodiment of the meat processing example) or a desired combination of gases.

The lid may be affixed to the container by clips which have a general “U” shape with one leg of the “U” engaging with the container rim and the other with the lid. The clips allow the lid to be maintained in sealing contact with the container to provide a fluid tight seal, thereby maintaining the desired atmosphere and/or pressurization within the container. The clips also facilitate a mechanical connection between the container body and the lid which assists with the overall structural integrity of the container.

Once filled with the desired ingredient or ingredients, the containers are placed in the inventory. If the ingredient is certain meats, for example beef primals, then the container may be retained in the inventory for a certain period of time to allowing ageing of the meat prior to processing while keeping bacterial growth to a minimum. For example, beef may typically be aged from five to seven days before it reaches a retail shelf. The time period for which the meat is aged will vary depending upon the number of factors such as the meat type and the cut type for example.

The location, “age” and identity of the ingredient(s) in each container is recorded and associated with the identity of the container in a database. In this way the system knows when a container can or should be removed from the chiller, and where to locate it so that the moving operation can be performed efficiently.

Once the meat cuts have aged, the containers are selectively transported to a production area generally referenced 4 which has at least one production cell consisting of one or more machines sequentially arranged to produce one or more retail products from the ingredients provided in the containers. In a preferred embodiment, a dedicated production line is provided for each primary product, for example bone in, roasts, sliced, mince, diced/strips, crumbing, sausage, chicken.

At the end of the processing stage the retail ready products are wrapped. In this example, since the products are meat products they will typically be placed on plastic trays and wrapped in a plastic film. At this point the products are not labelled, and are identified independently of any label. In a preferred embodiment the products are identified by their position or location on the conveyor, or in the accumulation chiller (described further below).

The wrapped products from the production cell are then transported to a buffer chiller or accumulation chiller 5.

Referring to FIG. 2, the output stage of the production cell is shown diagrammatically in plan view along with a diagrammatic view of automated storage apparatus 8 within the buffer chiller 5. The output stage of the production cell includes a flow wrapper which provides the processed meat products in a cabinet ready (i.e. retail ready) package. This will usually consist of over-wrapping a tray on which the product has been placed with clear plastic film. In FIG. 2, the production cell 4 has an infeed conveyor assembly 6. As each wrapped product exits the production cell 4, the infeed conveyor assembly aligns the packages (if necessary) and is indexed until a shelf lot of products is formed. A shelf lot comprises a predetermined number of wrapped products, the exact number being dependent on the package size. In a preferred embodiment the number of products is 16, although this number may be increased or decreased depending upon the overall design of the system.

Once a shelf lot has been formed on conveyor 6, the conveyor assembly streams the shelf lot onto a conveyor 7. In a preferred embodiment conveyor 7 consists of a plurality of moveable fingers or individual rollers 30 which are driven so that the shelf lot moves as a group onto conveyor 7 with a desired (preferably substantially even) spacing. The conveyor is stopped when the products are in the required position adjacent to a shelf for transfer as will be described further below.

The accumulation device includes a carousel generally referenced 10 having a number of product support structures which take the form of shelves formed by individual elongate projecting elements 12 there are laterally spaced and arranged in horizontal rows. The elements 12 are preferably strong yet resilient element and are not prone to corrosion. We have found that a pultruded material such as that sold under the trade mark Pultron™ is a suitable material. The elements 12 are located sufficiently close to each other in a horizontal direction so that standard size retail meat packs are easily supported yet there is sufficient space between the elements to ensure that there is free air circulation so that there is significant volume of air impinging on the surfaces of the retail pack which ensures the contents of the pack are kept at a desired cool (preferably just above freezing) temperature. The elements 12 are spaced in a vertical direction to allow sufficient space to accommodate the height of the required size of retail pack.

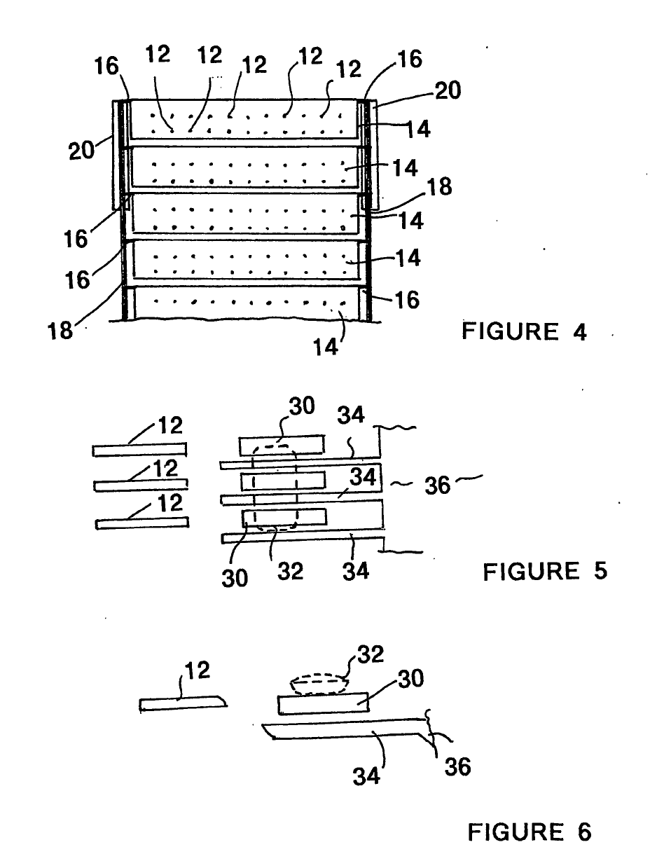

As can be seen in FIGS. 3 and 4, the carousel system includes a number of shelf units 14, each of which is rotatably connected by connector 16 to a flexible support such as chain 18. The chain is in turn supported by rotatable sprockets 22 thereby forming a revolving carousel where the shelves formed by the elements 12 can be moved in the vertical direction for loading, unloading and storage purposes. As shown in this example, each shelf unit 14 preferably has a plurality of rows of shelves formed from the elements 12. However, a greater or lesser a number of shelves may be provided depending upon the dimensions of the retail packs to be stored using the system.

A control system 22 which is represented diagrammatically in FIG. 3 is used to index the carousel by rotation of the sprockets so that the required shelf is in the correct position for transfer of the retail products to or from conveyor 7. The control system 22 also controls other aspects of the operation of the buffer chiller and associated apparatus such as the conveyor systems and transfer device (referred to below). The control system is preferably implemented using a computing device that interfaces with the apparatus and with human interface devices such as a user display and input device.

Referring out to FIGS. 5 to 9, the transfer of products from conveyor 7 onto the shelves formed by elements 12 will now be described.

As can be seen in FIG. 5, the rollers 30 of the conveyor 7 support a packaged product 32, which is shown in broken lines. The shelf elements 12 are adjusted by the control system to be in substantially the same horizontal plane as the rollers 30. Provided beneath the shelf elements 12 and the rollers 30 is a number of finger elements 34 that together comprise part of a comb-like transfer device which is generally referenced 36. As can be seen from the drawing, the fingers 34 are arranged so that they may interdigitate with the elements 12 and the role as 30. The arrangement is more clearly shown in side elevation which can be seen in FIG. 6.

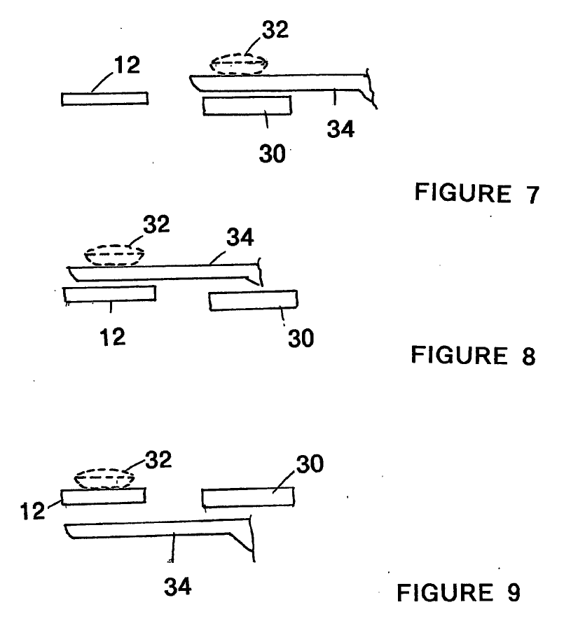

In FIG. 7 a first step in a transfer operation is shown. The transfer device 36 has been moved in an upward vertical direction, which has lifted the package 32 off the rollers 30.

In FIG. 8, the next step the operation is shown whereby the transfer device 36 is moved toward the accumulator apparatus so that the package 32 is provided in a position above the elements 12.

The final step the operation is shown FIG. 9 where the transfer device 36 is lowered, which allows the package 32 to be received on the shelf formed by elements 12. The control mechanism 22 can then index the carousel so that the elements 12 move vertically (preferably in an upward direction in the example illustrated) so that a further shelf is provided ready for transfer of further product. Products may be removed by reversing the operation described above.

This method of using the interdigitating transfer device to lift the products, move laterally relative to the shelf and conveyor, and then lower the product onto the shelf or conveyor avoids the need to push the product across the shelf and conveyor structures. Therefore, any damage to the product itself to the wrapping is minimised. Since thin film plastic wrapping is usually used for many foodstuffs, it is particularly vulnerable to being punctured or torn during transfer operations which can limit the shelf life of the product or its saleability.

Furthermore, the use of a transfer device which includes a series of fingers, and the use of the spaced fingers, projecting shelf elements and conveyor rollers allows air flow around the product during the whole transfer process. Therefore, the product is continually kept within the required temperature parameters.

It will also be seen that the depth of each shelf may be sufficient to accommodate more than one retail pack. Therefore, packs may be loaded two or more deep on each shelf depended upon the pack size. Each time product is loaded onto the shelf, the stock unit number (SKU), Manufacturing Order, RFID which indicates origin (preferably the RFID of the container from which the product originated in the primal chiller), time and number of packages on the current shelf will be recorded by control system. A message containing this data is sent to the enterprise resource planning system which is part of the overall control. The data may then be used upon receipt of a retail store order to enable an appropriate retail pack to be identified, selected, and the position of the shelf moved so that the selected product can be transferred from the shelf for delivery to satisfy the order.

From processing through to packing the retail order, the location of the products and certain other details such as SK U (and for the accumulator, time of put away) are held in the plant control system. When the packs are required to fulfil a store order, shelves rotate until the required shelf based on the product type/size and time of manufacture is available, and the packs are then loaded onto the conveyor and despatched to a weigh labeller. The accumulator moves the required shelf to the specified location and transfers product from the shelves to the infeed/outfeed conveyor 7. The transfer mechanism is operated in reverse order so that retail packs are transferred from the shelf to be conveyed to the weigh labeller. After being labelled to store requirements, the packs are sorted to be containerised in a container such as that described above to store the primal cuts, for delivery to the retail store.

We have found that the appearance of red meat, and therefore its retail shelf life, can be improved by conditioning the meat. The conditioning process is performed by keeping the meat at as a low a temperature as possible without allowing it to freeze for a predetermined period of time. This reduces oxygen consuming reactions in the meat, leading to an enhanced degree of oxygenation and increased colour stability. Therefore, rather than follow conventional practice and have the processed red meat products delivered to retail as soon as possible, we have found that it is advantageous to allow a conditioning period. This can be implemented in the accumulator since the time of delivery of each package to the accumulator is recorded. Therefore, when a retail order is received, the control system checks the data to determine which products have been in the accumulator for the required period of time (typically about 7 hours-24 hours), and product that meets the requirements is despatched. Also, the control system can monitor demand for products (for example by looking at current or historical order information and economic and seasonal information) and adjust processing so that products are introduced into the accumulator at a rate whereby they will have sufficient time to be properly conditioned prior to despatch.

The accumulator provides a solution to warehousing of retail packs in a manner which provides many benefits. It allows the packs efficiently cooled to meet the process requirements. It enables the packs to be automatically accumulated and tracked without labels. This means that labelling can take place after receipt of orders and prior to dispatch without any manual intervention such as having to be unpacked from cartons or crates. It also allows flexibility in allocation to retail stores. That is to say orders can be me down to individual packs or alternatively allocation can be made individually across multiple stores. It also provides an automated method for warehousing and handling retail packs prior to retail distribution.

Where in the foregoing description reference has been made to specific components or integers of the invention having no equivalents, then such equivalents are herein incorporated as if individually set forth.

Although this invention has been described by way of example and with reference to possible embodiments thereof, it is to be understood that modifications or improvements may be made thereto without departing from the scope of the invention.

1. A meat product distribution method comprising the steps of
providing a plurality of packaged retail cabinet ready meat products,
introducing the plurality of packaged retail meat products into a central storage facility having a plurality of moveable product carrying structures in a temperature controlled environment and having a transfer means to transfer the packaged products to or from the product carrying structures,
identifying the location of the packaged products within the storage facility,
removing selected products in response to receipt of an order for the selected products by moving one or more of the product carrying structures to the transfer means, and distributing the products to fulfill the order.

2. A method as claimed in claim 1 including the step of storing the packaged products in the central storage facility for a predetermined period of time.

3. A method as claimed in claim 1 wherein the method includes the step of identifying the packaged products other than by using a label, receiving the order, and labelling the retrieved products according to the order.

4. A method as claimed in claim 1 wherein the method includes storing individual cabinet ready packaged meat products in the central storage facility.

5. Meat product distribution apparatus including
a storage facility having a plurality of moveable product carrying structures in a temperature controlled environment,
a conveyor means to introduce or remove packaged cabinet ready retail meat products to or from the storage facility,
transfer means to transfer the packaged products to or from the conveyor means and the product carrying structures,
identification means to identify the location of the packaged products within the storage facility, control means to receive an order for selected products and cause the transfer means to remove the selected products from the product carrying structures, and use the conveyor means to convey the selected products from the storage facility so that the products may be distributed to a remote location to fulfill the order.

6. A method of centralised distribution of meat, the method including the steps of
storing packaged retail meat products in a central storage facility,
monitoring the time at which each product was introduced into the facility,
receiving an order for products stored in the facility, and
selecting products from the facility that have been stored therein for a predetermined period of time to satisfy the order.

7. A method as claimed in claim 6 wherein the predetermined time period is determined dependent on the product type or the product processing history.

8. A method of centralised distribution of meat, the method including the steps of
storing packaged retail meat products in a central storage facility,
monitoring demand for the meat products,
introducing further packaged retail meat products into the central storage facility dependent on the demand such that the retail meat products are stored in the central storage facility for a predetermined period of time calculated to enhance the retail shelf life of the meat.

9. A method as claimed in claim 8 wherein the predetermined time is calculated dependent on one or more factors including: the type of meat; the type of meat cut; the slaughter process used; the cooling profile of the meat prior to introduction into the storage facility; the demand for the product; the type of processing that the product has undergone; the type or location of a retail outlet to which the product is to be dispatched.

10. A method of centralised processing and distribution of meat, the method including the steps, of
placing post slaughter meat in a reusable container and storing the meat within the container,
removing the meat from the container and processing the meat into retail meat products,
packaging the retail meat products,
storing the packaged products in a central storage facility for a predetermined period of time,
receiving a retail order,
selecting packaged products in the central storage facility dependent on the retail order,
placing the selected products in a reusable container, and
transporting the selected products in the container to a retail facility.

11. A method as claimed in claim 10 wherein the method includes the step of storing the products in the central storage facility without being labeled.

12. A method as claimed in claim 10 wherein the method includes the step of labeling the products prior to the step of placing the selected products in a reusable container for transport to the retail facility.

13. A method as claimed in claim 10 wherein the predetermined period of time is calculated to enhance the shelf life of the retail meat product.

14. A method of centralised distribution of meat, the method including the steps of
providing a plurality of packaged retail meat products,
introducing the packaged products to a central storage facility having a plurality of movable product carrying structures,
identifying the packaged retail meat products by means other than a product label,
removing selected products from the storage facility in response to receipt of an order for the selected products,
distributing the products to fulfill the order.

15. A method as claimed in claim 14 wherein the method includes the step of storing the products in the central storage facility without being labeled.

16. A method as claimed in claim 14 wherein the method includes the step of labeling the products during or after removal of the products from the storage facility.

17. A method as claimed in claim 14 wherein the meat products are stored in the central storage facility for a predetermined period of time calculated to enhance the shelf life of the retail meat product.

18. A method of centralised distribution of meat, the method including the steps of
providing a plurality of packaged retail meat products,
introducing the packaged products to a central storage facility having a plurality of movable product carrying structures,
identifying the packaged retail meat products by recording or identifying the location of the relevant product,
removing selected products from the storage facility in response to receipt of an order for the selected products,
labeling the products, and
distributing the labeled products to fulfill the order.

19. Automated storage apparatus for storing articles in a temperature controlled environment, the apparatus comprising
a plurality of article carrying shelves arranged one above another on a carousel, the shelves being vertically moveable by rotation of the carousel to facilitate placement or removal of articles on or from the shelves, each shelf comprising a plurality of laterally spaced elongate projecting support members to carry one or more articles.

20. Apparatus as claimed in claim 19 wherein the lateral spacing between adjacent support members is selected dependent on the size of the articles to be stored.

21. Apparatus as claimed in claim 19 wherein the apparatus includes a control system to track the articles stored therein independent of any label that may be carried by an article.

22. Apparatus as claimed in claim 21 wherein the control system tracks articles based on location within the apparatus.

23. Automated storage apparatus for storing articles in a temperature controlled environment, the apparatus comprising
a plurality of product carrying shelves arranged on a carousel, the shelves being moveable to facilitate placement or removal of articles on or from the shelves, each shelf comprising a plurality of laterally spaced elongate projecting support members,
a conveyor to transport articles to or from the apparatus, the conveyor including a plurality of spaced rollers, and
a transfer means for transferring articles between the conveyor and a shelf, the transfer means comprising a plurality of fingers adapted to interdigitate with the rollers to lower or lift articles to or from the conveyor and adapted to interdigitate with the elongate projecting members of a shelf to lower or lift articles to or from the shelf.

24. Apparatus as claimed in claim 23 wherein the transfer means is adapted to lift one or more articles from one of the conveyor or the shelf, and move in a direction parallel to the projecting members, the fingers and the rollers to lower the one or more articles onto the other of the conveyor or shelf.

25. A centralised distribution process for a perishable food product, including
providing a reusable container,
placing the product in the container and sealing the container
transporting the container to a central storage facility
removing the product from the container and wrapping the product
storing the wrapped product,
receiving a retail order for the product
retrieving the product from the storage facility
transporting the product to a retail outlet.

26. A centralised distribution process for a perishable product, including
transporting the product to a central storage facility,
wrapping the product in a retail package,
storing the wrapped product
receiving a retail order for the product from a retailer,
retrieving the product from storage,
labelling the product dependent on the retailers requirements
transporting the labelled product to the retailer

27. A centralised distribution process as claimed in claim 26 wherein the step of labelling the product includes affixing a price to the product, the price being dependent on the retailer's pricing structure.

28. A containerised distribution process for a perishable food product, including
providing a first reusable container,
placing the product in the container and sealing the container,
transporting the container to a central storage facility,
removing the product from the container and wrapping the product,
storing the wrapped product,
receiving a retail order for the product,
retrieving the product from the storage facility,
placing the retrieved product in a second reusable container,
sealing the container,
transporting the container to a retail outlet.

29. A containerised distribution process as claimed in claim 28 wherein the method includes the step of sterilising the first container for re-use as a first reusable container or for use as a second reusable container.
